(19) United States
(12) Patent Application Publication
(10) Pub. No.: US 2013/0045380 A1
(43) Pub. Date: Feb. 21, 2013

(54) SYSTEMS AND METHODS FOR PROCESSING AND DESPENSING FILLED MULTI-COMPONENT MATERIAL

(71) Applicants: Russell H. Lewis, San Diego, CA (US); Mihai Adrian Solomon, San Diego, CA (US)

(72) Inventors: Russell H. Lewis, San Diego, CA (US); Mihai Adrian Solomon, San Diego, CA (US)

(73) Assignee: RHINO LININGS CORPORATION, San Diego, CA (US)

(21) Appl. No.: 13/574,552

(22) PCT Filed: Jan. 21, 2010
(86) PCT No.: PCT/US10/21642

§ 371 Date: Oct. 22, 2012

(51) Int. Cl. C09D 121/00; B32B 27/06; B05D 5/00; B05B 7/26; C09D 175/04; C09D 175/02

(52) U.S. Cl. 428/339; 524/571; 524/507; 521/163; 521/170; 427/385.5; 239/310

(57) ABSTRACT

A filled multi-component material applied by a dispensing system is disclosed. The material can be produced by mixing a first reactive component comprising a resin and a filler with a second reactive component comprising a curing agent. The filler can comprise a hard filler and/or an elastic filler such as ground recycled tire material. The first reactive component and the second reactive component can be fed to a dispensing apparatus and mixed by a static mixer, each of which can be disposable. The mixture can then be dispensed onto a surface using air spray, airless spray or extrusion, for example. When applied to a surface, the mixture typically polymerizes and entrains the filler materials to provide a protective layer having improved properties. In certain embodiments, the filler materials can include recycled tires that have been ground into fine particles, providing environmentally friendly new products from old tires that typically end up as landfill.

### FIELD OF THE INVENTION

Embodiments of the present invention relate generally to the field of multi-component materials, including coating applications, and in one embodiment, to a method and apparatus for processing and delivering fluidic viscous multi-component materials.

### BACKGROUND SECTION

Multi-component materials such as those described herein typically comprise a polymeric matrix that may contain filler materials that contribute volume and desirable physical and/or chemical characteristics. These multi-component materials are used for many purposes, including coatings for an object or surface, to treat or protect the underlying object or surface or to impart desired appearance, texture or other properties to the underlying object or surface. Examples of suitable polymeric matrix materials can comprise a variety of polymers, including polyurethanes and polyureas, and various filler materials can be used.

Multi-component materials can be produced from combining two or more reactive components. Typically, the reactive components are initially in a liquid stage and are shipped and stored separately until the time of their application. Then the components are mixed together at a specified proportion ratio under conditions that promote polymerization or solidification. Once properly mixed in a liquid state, the material can be applied using air spray, airless spray, pouring, painting, or extrusion, for example, to a surface or object to be coated, or into a mold to form an item of a desired structure. Typically, multi-component material can be produced by mixing a liquid resin with a liquid curing agent, and once mixed, these materials can cure rapidly into a solid state (i.e. the mixture solidifies). The two or more materials can be mixed together in a specific, predefined proportion, which can be referred as a mix ratio. The mix ratio is selected to provide a desired polymeric composition, and typically converts all of the curing agent and most of the resin into a polymeric matrix. When mixed, the reactive components may polymerize into a solid (a polymeric matrix), which may be rigid or flexible. When one or both of the liquid materials comprising the reactive components also comprises a non-reactive material such as a particulate solid, the non-reactive material, referred to herein as a filler, becomes fixed in the polymeric matrix.

The resin typically comprises at least one polyalcohol (e.g., a diol or triol) or at least one polyamine monomer (e.g., a diamine or triamine); mixed monomers such as an aminoalcohol can also be used. Commonly used polyalcohols include ethylene glycol, propylene glycol, diethylene glycol, triethylene glycol, tetraethylene glycol, 1,3-propanediol, 1,4-butanediol, 1,5-pentanediol, or 1,6-hexanediol, as well as aromatic diols like bisphenol-A. Commonly used polyamines include ethylene diamine, 1,3-diaminopropane, 1,4-diaminobutane, 1,5-diaminopentane, 1,6-diaminohexane, polyoxypropylene amines, and aromatic amines such as phenylene diamine, isophorone diamine (IPD), and diethyltoluene diamine. The resin may also include other components such as a solvent or carrier that does not become part of the polymeric matrix, and one or more catalysts that promote reaction of the resin components with the curing agent. In some embodiments, no solvent or carrier is present. The resin typically contains a diol or diamine, which reacts with the curing agent to form a linear polymer.

In some embodiments, the curing agent comprises a diisocyanate or polyisocyanate. Commonly used curing agents include methylene diisocyanate, ethylene diisocyanate, 1,3-propanediisocyanate, 1,4-butanediisocyanate, 1,5-pentanediisocyanate, 1,6-hexanediisocyanate, hexamethylene diisocyanate (HDI), and isophorone diisocyanate (IPDI), and aromatic diisocyanates, such as methylene diphenyl diisocyanate (MDI), toluene diisocyanate (TDI), and naphthalene diisocyanate. Isocyanate groups in these curing agents form a urethane linkage with alcohol groups of the resin material to form polyurethanes, or they form urea linkages with amine groups of the resin material to form polyureas. Particular embodiments of the invention can employ a diol component such as 1,4-butanediol, 1,6-hexanediol, or a bis-phenol such as bisphenol A to form a polyurethane matrix when combined with a diisocyanate, such as HMDI, methylene diisocyanate, and the like. Methods for making and using such resin and curing agents for preparation of a polymeric matrix are well known in the art.

The resin may also comprise a cross-linking agent. Suitable cross-linking agents may be polyalcohols that contain at least three alcohol groups per molecule, or polyamines that contain at least three amino groups per molecule, permitting linear polymers to become cross-linked with each other. Alternatively, the cross-linking agent can be a polyisocyanate having more than two isocyanate groups. The cross-linking agent commonly increases hardness and rigidity of the polymeric matrix.

The multi-component material can also include one or more suitable fillers. A filler is typically selected to impart desired properties to the filled material, and may be used to provide a significant fraction of the material's volume. One or more fillers can be combined with a liquid component used to form the polymeric matrix; for example, a filler may be added to a liquid resin suitable for forming a polyurethane or polyurea or mixture thereof, prior to mixing the resin with a curing agent that can promote polymeric matrix formation. The combination of liquid resin and filler is referred to herein as a base component. Note that it is also possible to combine fillers, catalysts, coloring agents, and other materials with the curing agent instead of or in addition to putting them into the resin mixture; but in certain embodiments, these materials are often admixed with the resin.

A filler can affect the multi-component material's physical proprieties, like stiffness, strength, and impact performance. Fillers can also provide a desired characteristic to the multi-component material, such as particular color, opacity, or conductivity, as well as provide greater thermal, sound insulation and/or fire retardant properties. In addition, fillers can be used to lower a multi-component material's formulation cost, as the filler can be less expensive than other components of the multi-component material. Exemplary fillers include milled glass, polyester, graphite, calcium carbonate and barium sulfate.

However, many fillers do not adhere well to a particular polyurethane or polyurea matrix. In addition, many fillers can decrease desired properties like elasticity, fatigue resistance, and impact strength. Some fillers can also be relatively expensive, thereby increasing costs. Further, some fillers may be toxic or harm the environment when manufacturing the filler or disposing of the filler.

In some embodiments, the multi-component material forms a solid, flexible layer of material, which may be formed on and, if desired, adherent to an underlying substrate or surface. Adhesion to the surface or substrate can, if desired, be promoted by treating the surface using conventional methods known in the art, such as roughening the surface or applying a primer that promotes bonding between the surface and the applied material. It can also be promoted by selecting precursors that produce a polymeric matrix that has good adhesion properties; such materials are well known in the art.

Selection of the filler material can provide desirable properties such as cushioning or ‘give’ to the layer of material where the polymeric layer would otherwise be relatively firm. Where still more flexibility is desired, the multi-component material may be formed as a foam by providing for formation of ‘bubbles’ or cells of gas (e.g., air or a volatile hydrocarbon). Formation of a foam can provide a multi-component layer that is softer and thus provides padding for a person walking on the material, or for protection of the substrate underlying the material, or both. It also can be used to increase the thermal insulation value provided by the multi-component material, as heat transfer through the material is reduced when the material is formed as a foam. Filled multi-component materials in the form of a foam, and methods for forming such materials as a foam, particularly where the material is formed by a spray application method, are not known in the art.

What is needed is a filler or combination of fillers that can be used in a multi-component material to remedy some or all of the above-mentioned disadvantages.

Conventional systems for handling, mixing and applying the components of a multi-component material are designed to handle low viscosity resins and hardeners, with low level of solid fillers incorporated in the resin. Fillers that contain larger particulate components, or mixtures of fillers having very different mixing properties, are generally incompatible with these conventional systems. Thus, what is needed is a system capable of mixing greater levels of fillers (including large particle fillers) incorporated in the resin in order to produce and apply multi-component materials with diverse types of fillers.

Conventional multi-component materials also tend to provide relatively smooth surfaces, while for some applications, it is advantageous to have a surface with a non-smooth surface texture. For example, surfaces to be walked on may provide better traction, especially when wet, if they contain fillers that promote increased rugosity. However, to date, fillers having this effect have not been useable with conventional multi-component material processing systems or spray applications. Moreover, it is desirable to have the capability to form such multi-component materials into a foam having a controlled amount of bubbles or cells incorporated into the flexible, solid product, and methods to make such foamed materials, particularly when using a spray-on method to form a layer of the foamed multi-component material on a surface or substrate, are not currently available.

Prior art systems generally meter the reactive components using multiple independent pumps, each pump with its own individual controllers and flow sensors to properly combine and mix the polymer matrix components. The added complexity is costly and makes the equipment less reliable in terms of variations in metering (less precision) as well as equipment failure. In addition, it is desired to have a precise and reliable metering system to meter the components of the multi-component material before mixing, so that, during mixing, specific, predetermined proportions of the components (the mix ratios) are closely maintained. Accordingly, in the present devices and systems, the first and second pumps optionally may use a common motive force for driving two pump mechanisms used to deliver, mix, or apply two components of the multi component material. By using two pump mechanisms driven by one motive force (e.g., an electric or pneumatic motor), the two pumping mechanisms can be coordinated to deliver first and second components in constant proportions. If necessary, gears or belts or other mechanisms can be included to provide the desired proportion (mix ratio) of the two components, so the amounts of the two components can be the same or different even though a single motive force is used to deliver two separate components.

Prior art systems typically use piston pumps for solid filled liquid resin material. However, piston pumps can provide non-uniform flow (i.e. a variation from a nominal, set, flow rate) due to the piston pump changing direction at the end of each stroke. Non-uniformity can produce mixing ratio variations that produce non-uniform multi-component product, where polymerization is incomplete, and is particularly problematic for some filled materials because it can produce localized regions of inferior product. For example, when applied as a relatively thin layer (e.g., less than about 1 cm in thickness, or less than about 5 mm in thickness), localized regions of high or low filler concentration can produce spots where the solidified material is weakened by having too much filler, or excessively stiff or brittle where too little filler is present. Maintaining a relatively homogeneous distribution of filler is thus especially important for embodiments described herein where the material is used to form a thin layer on a surface.

Some embodiments provide compositions of resin and curing agent comprising a finely divided particulate filler that are suitable for spray application. Application by spraying further complicates selection of filler materials and preparation of the resin and/or curing agent component. The reactive component containing a filler must be prepared as a suspension for spraying, and the filler must be sized suitably for spray application. The filler must be kept in a homogeneous suspension in one of the reactive components, typically the resin, while feeding it into a spraying device and mixing it in proper mix ratio with the other component (usually the curing agent), in preparation for spraying. It must then be formed into an aerosol with droplet size suitable for spraying onto a surface to be coated before polymerization occurs to an extent that interferes with spraying onto a surface. While spray-on materials such as polyurethane and polyurea materials that polymerize rapidly upon application are well known in the art, such materials having particulate fillers as described herein have not been available due to the complexity of forming a suitable homogeneous mixture for aerosol application to produce a uniform product.

Based on the abovementioned, what is needed are improved compositions, methods and apparatus, that will overcome the foregoing deficiencies of the prior art.

Such compositions, apparatus and methods will allow for the preparation of highly filled, viscous reactive components (resins and/or curing agents) for making filled multi-component materials, with precise metering to produce a consistent and homogeneous sprayed-on product, in a reliable manner, without the need for complex mechanisms.

### SUMMARY OF THE INVENTION

Embodiments of the present invention provide improved apparatus and methods for mixing, metering and dispensing fluid and/or viscous materials. In addition, the invention provides improved filled multi-component materials and filler-containing reactive component compositions as well as methods and apparatus for processing these precursors to form such multi-component materials with a high degree of uniformity and consistency. In certain embodiments, the invention provides an environmentally friendly multi-component material that contains recycled material such as ground rubber tire as a filler in a polymeric matrix, where the filler imparts desirable characteristics to the material including low cost and surface rugosity, while providing a strong and durable finished surface.

In one embodiment, the invention provides a reactive component composition comprising an elastic filler, typically a recycled material such as ground rubber tires, as a filler. In certain embodiments, the reactive component is a resin suitable for forming a polyurethane, polyurea or co-polymer of the two (i.e., a copolymer of polyurethane and polyurea). The composition can further comprise a curing agent present in a suitable mix ratio with the resin. In certain embodiments, this composition is mixed to provide a high degree of homogeneity of the reactive components and to keep the fillers suspended, so it is suitable for forming a homogeneous solidified product. In certain embodiments, the composition is formed by mixing the resin component and the curing agent under conditions to promote quick but not instantaneous polymerization. In certain embodiments, the composition is formed by mixing the resin and curing agent components and is then quickly dispersed into an aerosol while still in liquid form, i.e. before polymerization proceeds; this aerosol is suitable for spraying onto a surface and quickly polymerizes to form a multi-component material having filler(s) dispersed in a polymeric matrix. Optionally, the aerosol can include blowing agents and/or entrained air, as well as optional surfactants, to promote formation of a foamed polymerization product.

In one embodiment, a multi-component material includes a combination of hard fillers and elastic fillers. This can create a good balance between increased hardness plus tensile strength, and increased elasticity capabilities of the material. As well, this combination can improve the adherence of the filler to the polymeric matrix to promote strength and resist damage. The hard fillers are typically relatively uniform in size, i.e., they have a relatively narrow size distribution. The small particle size distribution of the hard fillers can also improve the flow ability of the medium sized elastic filler particles. The elastic fillers are generally far more difficult to prepare with highly uniform size and properties, but if properly chosen and incorporated can be very useful for providing a surface that has high impact resistance but also has enough ‘give’ and surface texture to provide a high-friction surface. Further volume, give or cushioning, and thermal insulation, as well as reduced weight, can be provided by forming the material as a foam. Methods for producing a foam by forming small bubbles in the material during mixing or aerosol formation, or during application or curing are known in the art and are discussed herein.

In one embodiment, recycled rubber material (e.g. from recycled tires) can be used as elastic filler for a multi-component material. The use of recycled materials can be environmentally friendly, particularly where the material is not very biodegradable and would persist for many years in a landfill. In addition, the use of recycled rubber can significantly reduce formulation costs, as it can be less expensive than other similar types of filler that could be used, and also less expensive than the materials forming the polymeric matrix.

One embodiment includes a combination comprising ground rubber tire material as a filler component, typically having a medium particle size distribution, in combination with a resin plus curing agent system that provides a short gel time polymeric matrix. Such a multi-component material—applied by means of atomization or airless spray, for example—can have several advantages. First, the material's external surface can have a high rugosity (variations or amplitude in the height of surface irregularities) when compared with non-filled material. This external surface rugosity can be created by the presence and dispersion of the medium sized rubber filler particles. This characteristic can provide a high friction coefficient of the rubber filled multi-component material. It also provides a very cost-effective increase in volume while retaining the desired toughness and other properties of the polymeric matrix when used in appropriate proportion.

According to one embodiment, a multi-component material comprising a recycled ground rubber tire filler is prepared. Optionally, the material also comprises a hard filler material. The process of preparing the material includes providing a first reactive component comprising a resin and at least one filler material, such as a recycled ground rubber tire filler, and providing a second reactive component comprising a curing agent capable of curing the resin to form a polymeric matrix. The first reactive component can be heated and mixed in a first reservoir so that the first component is substantially homogeneous. Maintaining homogeneity in this material is complicated by the presence of the insoluble filler material, but is needed to provide a high-quality, long-lasting multi-component material product.

In some embodiments, the filled multi-component material is formed into a layer that is substantially bubble-free, i.e., it is formed as a solid material rather than a foam. Methods for forming the polymeric matrices described herein without a filler material into substantially bubble-free layers (non-foamed materials) are well known in the art, and can be applied with the filled materials: the filler materials generally do not promote bubble formation or foaming when used as described herein. However, methods for producing foamed materials from the polyurethanes and other polymers described herein that can be used as the polymeric matrix for the filled materials are also known in the art, and can be combined with the filler materials described herein to further customize the properties of the filled multi-component materials. Thus each of the embodiments described herein can, unless otherwise indicated, be used with a suitable blowing agent and the like to form a foamed product, or it can be used to form a substantially solid product.

One embodiment of the invention is a substantially homogeneous mixture comprising:
(a) an elastic filler;
(b) at least one polyisocyanate monomer; and
(c) at least one polyalcohol monomer, or polyamine monomer (or mixture of a polyamine monomer and a polyalcohol monomer), which is capable of forming a polyurea, polyurethane or copolymer of polyurethane and polyurea by reacting with the polyisocyanate monomer.

Frequently, the elastic filler comprises 5-70% ground rubber tire filler having a particle size of about 20 mesh or smaller (‘smaller’ as used herein to describe mesh sizes means smaller in particle size, which corresponds to a numerically larger mesh number). In some embodiments, the filler has a particle size between about 20 mesh and about 200 mesh, preferably between 20 and 100 mesh. The mixture may also comprise a second filler, which can be a hard filler. Optionally, the mixture further comprises a catalyst to promote polymer forming reaction between the polyisocyanate monomer and the polyalcohol and/or polyamine monomer.

In some embodiments, the mixture is prepared under conditions where it will polymerize rapidly, and is promptly applied to a surface to be coated. It may be applied in a thin layer, e.g., a layer less than 10 mm in thickness and preferably less than about 5 mm in thickness. The conditions are preferably controlled to provide polymerization rapidly, e.g., rapidly enough so the solid formed by polymerization remains substantially homogeneous and the particulates or fillers added to the mixture remain distributed throughout the polymeric matrix. In some embodiments, the mixture is converted into an aerosol for spraying onto a surface. Optionally, the mixture can include one or more blowing agents and/or surfactants to promote formation of a foamed product.

In another embodiment, the invention provides a solid multi-component material comprising a polymeric matrix and elastic filler produced by polymerization of the mixture described above, wherein the elastic filler comprises a recycled material such as ground rubber tire. The recycled material is typically a rubber or synthetic polymer that can be produced cheaply; reusing it keeps it out of a landfill. It is processed by careful grinding to produce small particles of moderately uniform size, typically less than 20 mesh for optimum performance in the multi-component mixtures described herein. In some of these embodiments, the polymeric matrix comprises polyurethane or polyurea (which includes a copolymer of polyurethane and polyurea), and it may contain a mixture of polyurethane and polyurea. Frequently, the polymeric matrix consists of, or consists essentially of, polyurethane, polyurea, or a mixture or copolymer of these. In some embodiments, the solid multi-component material is produced by spraying the mixture as an aerosol onto a surface under conditions where polymerization occurs. Typically, polymerization occurs rapidly enough to provide a solid material that is substantially homogeneous and does not run or drip or sag significantly, i.e., the mixture polymerizes while the particulates and/or fillers remain suspended in it, and it polymerizes rapidly enough to produce a coating whose thickness does not change by more than about 50% after the material is sprayed onto the surface, preferably not more than about 25%.

Note that the thickness of a layer formed by spraying a multi-component reaction mixture onto a surface under conditions that promote rapid polymerization will naturally vary over the treated area, as the amount applied cannot typically be controlled exactly, so the thickness of such layers as described herein refers to an average thickness over a treated surface or area. In some embodiments, the actual thickness will be within 50% of the average thickness over at least 90% of a treated object or area. In other embodiments, the actual thickness will be within about 40% of the average thickness over at least 80% of a treated object or area. In some embodiments, more than 50% of the treated area or object will be within about 30% of the average thickness. The preceding discussion about the thickness changing refers specifically to changing thickness at a given point that would result from the material running or sagging after application and before hardening to a final thickness.

In some embodiments, a blowing agent such as water, certain halocarbons such as HFC-245fa (1,1,1,3,3-pentafluoropropane) or HFC-134a (1,1,1,2-tetrafluoroethane), or a volatile hydrocarbon such as n-pentane can be included in the multi-component material. The blowing agent can be included in the resin, or it can be admixed with the other components as an auxiliary stream when an aerosol or spray stream is formed from the resin and the curing agent or hardener. The blowing agent promotes formation of small bubbles or cells within the matrix as polymerization occurs, producing a layer with a foam texture. The degree of foaming is readily controlled by selecting a suitable blowing agent and using an appropriate amount of the blowing agent to achieve the desired foam texture. As an alternative, the mixture can be mechanically ‘frothed’ with air to entrain air bubbles to form a foam structure if desired.

Control of the structure of the foam, including adjusting the density and size distribution of bubbles, is readily accomplished by methods known in the art, including controlling the amount of blowing agent used. A small amount of water, for example, can be included in the resin for a polyurethane; when admixed with a suitable isocyanate curing agent, the water causes formation of CO₂, which forms cells within the polymerizing matrix. In addition, the use of surfactants is known to further control the texture of a foam formed in such polymeric matrices. Surfactants to modify the characteristics of the polymerization mixture are known in the art, and can be used to regulate cell size, stabilize cell structure, and slow or prevent collapse of cells during foam formation. Rigid foam surfactants are known for making very fine cells and a high ‘closed’ cell content. Flexible foam surfactants are designed to stabilize the reaction mass while promoting open cell formation and reducing shrinkage of the foam.

In another embodiment, the invention provides a system for use in the preparation and application of components used to make the multi-component materials described herein.

The first reactive component (resin) and the second reactive component (curing agent) can also be metered using respective first and second pumping mechanisms so a predetermined ratio of the first reactive component and the second reactive component are outputted from the respective first and second pumping mechanisms. The first reactive component, which comprises a filler material and thus needs special treatment to maintain homogeneity, can be gravity fed to the first pumping mechanism through a supply line. The supply line connecting the first reactive component reservoir with a pumping mechanism to transfer the first reactive component out of its reservoir can be subject to clogging, particularly when pumping stops and the filler(s) in the first reactive component tend to settle out or rise to the surface, depending on their densities. Commonly, at least one filler component is dense enough to settle, and the supply line can, if desired, be configured to allow for such settling without causing the dense particulates to accumulate in the pump inlet, where they may cause problems. In some embodiments, the pumping mechanism is positioned above the level of the first component in its container, so that particulates in the supply line settle away from the pump when the system is not operating (no flow through the supply line). In some embodiments, at least a portion of the supply line is lower than an inlet of the first pumping mechanism. Optionally, the supply line can include a blind downward extension that extends below the lower inlet of the first pumping mechanism to catch settling particulate materials. Optionally, the supply line includes a u-shaped section or similar low point to serve this function. Optionally, the supply line can include a valve to shut off material flow, or a three-way valve to permit material in the lines to be removed or recycled into the container for the first reactive component, or a backflow prevention valve to prevent material from settling into the pump inlet. The supply line can be heated using a heating element to facilitate maintaining the homogeneity of the first component.

The first and second pumping mechanism can be two separate pumps, or they can be two pump heads connected to a single motive force. The two pumps can be the same type of pump, or they can be different types of pumps. In some embodiments, each is selected from a gear pump and a piston pump. In certain embodiments, at least one and preferably both are gear pumps. In some embodiments, the first and second pumping mechanisms are gear pumps, and optionally they can be two separate gear pump heads driven by a common motive force. The common motive force can be provided by a motor coupled to the first and second gear pump heads via a common drive shaft and/or by a common rigid mechanical connection or belt arrangements.

The first reactive component and the second reactive component can also be mixed using a static mixer and dispensed onto a surface. The step of dispensing can include an application process selected from the group consisting of air spray, airless spray, pouring, painting, rolling, and extrusion. The mixed first and second reactive components cure into a solid state or a foamed solid on the surface.

In a particular embodiment, the resulting multi-component material can comprise between 20% to 80% polymeric matrix monomers by weight, between 5% to 70%, hard filler by weight, and between 5% to 70% elastic filler (e.g., recycled ground rubber) by weight. The hard filler can have a smaller particle size than the recycled ground rubber tire filler. Other components such as a catalyst to promote polymerization and any desired colorants or blowing agents can also be included, but generally represent small percentages of the material.

According to one embodiment, a multi-component material dispensing system can be configured to spray a multi-component material comprising a first reactive component and a second reactive component. The first reactive component can comprise a resin and a particulate filler with a particle size distribution of about 20 mesh or smaller particle size (e.g., down to about 100 mesh, 200 mesh, or even smaller particle size), and the second reactive component can comprise a curing agent.

The dispensing system can include a dispensing apparatus comprising first and second inlet ports, an outlet port and a mixing chamber in fluid communication with each of the first and second inlet ports and the outlet port. A mixing element can be at least partially disposed in the mixing chamber, and configured to mix the first reactive component and the second reactive component. The dispensing system can also include a first reservoir configured to store the first component. The first reservoir can have a heating element configured to heat the first component to a predetermined temperature while the first component is stored in the reservoir and a mixer configured to mix the first component while the first component is stored in the reservoir. In addition, the dispensing system can include a second reservoir configured to store the second reactive component. The system can further include a first pumping mechanism adapted to pump and meter the first reactive component from the first reservoir to the first port of the dispensing apparatus. The first pumping mechanism and the first reservoir can be physically connected by a heated transfer line. A second pumping mechanism can also be included and adapted to pump and meter the second reactive component from the second reservoir to the second port of the dispensing apparatus. The first and second pumping mechanisms can be any suitable type of pump or pump head; in some embodiments they are two separate pump heads of gear or piston pumps. They can, for example, be separate gear pump heads driven by a common motive force.

Other features and aspects of the invention will be apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The following drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a schematic illustration of a multi-component dispensing system in accordance with one embodiment.

FIG. 2 is a logic flow diagram of a process for mixing, metering and dispensing a multi-component material in accordance with one embodiment.

### DETAILED DESCRIPTION OF THE EXEMPLARY EMBODIMENTS

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the preferred embodiments of the present invention.

As used herein, the term “pump” when used as a noun refers to any motive source capable of physically moving a material such as, without limitation, a fluid or viscous material.

As used herein, the term “reactive mixture” refers to any multi-component reactive mixture where each individual component (e.g., first and second reactive components), when mixed, result in a chemical reaction whereby the substantially liquid individual components harden into a substantially solid state after a relatively brief period of time. Typically, the reaction proceeds sufficiently for the material to retain its shape within minutes after mixing or after exposure to air, and at that point it behaves as a solid rather than a liquid, though it may not be fully cured or hardened so quickly. Examples of reactive components used to form a mixture include, without limitation, isocyanate and polyol, which when combined form a mixture that reacts into a substantially solid polyurethane coating.

As used herein, the term “dispensing” refers to any sort of release or provision of one or more materials to a desired location. Dispensing may comprise, without limitation and for example only, spraying (atomized or airless), pouring, and spattering-coating.

As used herein, “substantially homogeneous” means the mixture comprises a solution or polymeric matrix that is thoroughly mixed. Where filler or particulates are present, they are randomly distributed and are mixed throughout the sample, and the particulate materials have not settled out of solution or floated to its surface. While there may be small variations and gradients in the composition from point to point in the mixture, especially where particles are suspended in a solution or polymeric matrix, the composition of samples from the ‘top’ and ‘bottom’ of the mixture differ from the average overall composition by no more than about 50% with respect to amount of particulate per mL of material, for example; similarly, the composition of the liquid phase of the mixture differs by no more about 50% from the average overall composition.

“Elastic filler” as used herein refers to a material that is particulate in form but is not ‘hard’ like a granular powder or crystalline material. Elastic filler materials are capable of deforming, e.g., being compressed, by at least 10% under stress without breaking down. Examples of elastic filler materials could include soft plastics (e.g., polyethylene, polypropylene, polystyrene, etc.), rubber (synthetic or natural), sawdust or other finely divided plant materials, and the like.

A specific embodiment uses a fine particulate made of natural or synthetic rubber, or a blend of these, and used tires can be processed to make a particular embodiment of elastic filler that works well in the multi-component materials of the invention. Spent tires from automobiles, trucks, planes and the like that would typically end up in a landfill can be processed to make an elastic filler material of suitable size (ca. 20-200 mesh) that is very compatible with polymerization mixtures of polyurethane or polyurea, etc. that are suitable for spray applications. This filler has been found to integrate well with some polymerized multi-component material polymers such as polyurethane and/or polyurea. Thus in one embodiment, the multi-component materials used in the compositions, processes and apparatus described herein comprises recycled tire as an elastic filler in a reactive mixture or polymeric matrix that comprises polyurethane or polyurethane precursors.

The filler materials described herein are relatively small particles, e.g., having a size that is less than half of the thickness of a layer of the multi-component material in which they are used. Typically they are under 1 mm in size, frequently under 0.8 mm, and optionally under 0.5 mm in size, although their size and shape can be irregular. ‘Hard’ fillers are often easier to mill to a fairly consistent size, while the elastic filler materials are often resistant to crushing and can be more difficult to prepare with a narrow size range. Accordingly, the elastic fillers used herein may be larger in size, and have a larger size range than the hard fillers.

Particle sizes are described herein using mesh sizing, which is well known in the art and is based on use of a sieve to sort particles by size. For certainty, the mesh sizes referred to herein correlate with effective particle size according to the following chart:

| Particle Size (mm) | Mesh size |
|---|---|
| 0.853 | 20 |
| 0.710 | 25 |
| 0.599 | 30 |
| 0.500 | 35 |
| 0.422 | 40 |
| 0.354 | 45 |
| 0.297 | 50 |
| 0.152 | 100 |
| 0.125 | 120 |
| 0.104 | 140 |
| 0.089 | 170 |
| 0.075 | 200 |
| 0.053 | 270 |
| 0.044 | 325 |
| 0.037 | 400 |

As the chart shows, a smaller particle has a higher numerical mesh size; thus when describing a particle by mesh size herein, a ‘smaller’ size means a smaller particle, which would be described by a larger mesh number. Particles defined by a mesh size refer to particles wherein at least 90% of the material by weight has the described sizing. Where an upper and lower limit are described, at least 90% of the material falls within the range of mesh sizes.

One embodiment of the invention is an improved mixing and dispensing apparatus for use in multi-component coating applications. This embodiment seeks to overcome the limitations and deficiencies of the prior art. As discussed in greater detail subsequently herein, these deficiencies are overcome by providing a system capable of mixing and dispensing a multi-component material comprising relatively large particle sized filler, such as recycled tire material.

Although embodiments of the present invention primarily refer to a two component multi-component material, it is appreciated that different materials can be used. A two component polyurethane material can consist of a polyurethane resin and a curing agent or hardener and may also contain a polymerization catalyst. These components are typically shipped and stored as separate materials (e.g., resin is packaged separately from curing agent) until the time of application. Then, the components are metered and mixed together at a particular proportion or mix ratio. Fillers may be present in the resin or curing agent, or may be added at the time the mixture of resin and curing agent is being prepared. Once mixed, these materials are applied by, for example, air spray, airless spray, extrusion, etc. These materials, in general, also cure (react) rapidly once mixed.

Before mixing, the resin and curing agent are in a liquid or viscous stage. Once mixed, the curing process starts, and at the end of the process the mixed and cured material is solidified. Suitable conditions and catalysts for promoting the curing process are known in the art.

In some embodiments, the polymeric matrix comprises a polyurethane, and the polyurethane is made from a diol selected from ethylene glycol, propylene glycol, diethylene glycol, triethylene glycol, tetraethylene glycol, 1,3-propanediol, 1,4-butanediol, 1,5-pentanediol, or 1,6-hexanediol; however, other suitable diols and polyols known in the art can of course also be used, such as aromatic diols like bisphenol-A; mixtures of these diols can also be used.

In some embodiments, the polyurethanes and/or polyureas are made from a di-isocyanate selected from methylene diisocyanate, ethylene diisocyanate, 1,3-propanediisocyanate, 1,4-butanediisocyanate, 1,5-pentanediisocyanate, 1,6-hexanediisocyanate, hexamethylene diisocyanate (HDI), and isophorone diisocyanate (IPDI), and aromatic diisocyanates, such as methylene diphenyl diisocyanate (MDI), toluene diisocyanate (TDI), and naphthalene diisocyanate.

In some embodiments, the polymeric layer comprises a polyurea, and the polyurea is made from a diamine selected from ethylene diamine, 1,3-diaminopropane, 1,4-diaminobutane, 1,5-diaminopentane, 1,6-diaminohexane, polyoxypropylene amines, and aromatic amines such as phenylene diamine, isophorone diamine (IPD), diethyltoluene diamine, and the like.

In some embodiments, the polyureas and polyurethanes comprise a cross-linker such as a triol or polyol, or a triamine or polyamine, to provide increased strength by cross-linking monomers.

Where a blend of polyurea and polyurethane is desired, it can be made using any of the above diisocyanates, in combination with a mixture of at least one diol/polyol and at least one diamine/polyamine. The ratio of urea components to urethane components can be adjusted as desired to provide suitable rigidity, elasticity, and strength in the final product; ratios of between 5:95 and 95:5 can be used, and ratios between about 20:80 and 80:20 are sometimes used.

The diol/polyol or diamine/polyamine material (resin) used for forming these polymeric layers by spray techniques may further include initiators that catalyze efficient, rapid polymerization when the mixture is prepared. The resin or curing agent may further include UV resistance promoters, colorants, flame retardants, and the like. Suitable materials and methods for producing the requisite polymeric layers of various compositions, colors, thicknesses, and other characteristics are thus known in the art.

In some embodiments, the filled multi-component material is desirably formed as a foam, having gas/air filled bubbles or cells within the polymeric matrix. Formation of such matrices as a foam is well known in the art, and methods for controlling the density of such foamed materials are also known. To form such foamed materials, a blowing agent may be admixed with the resin or the curing agent (more commonly with the resin), or it may be introduced into the mixture of resin plus curing agent during a spray application step. Alternatively, air may be entrained into the resin, curing agent, or mixture of resin plus curing agent to promote foam formation. As discussed herein a surfactant may also be added to the material (typically in the resin) to modulate foam formation and promote consistent formation of a foam of a desired texture. Thus in some embodiments, the components used to form the filled multi-component material can further include a blowing agent, a surfactant, and/or entrained air, which can be used to promote formation of a foamed structure.

Fillers can also be added to the resin and/or curing agent. In some embodiments, only one filler material is used, and it may be a ‘hard’ filler or an elastic filler material. In one embodiment, two main types of filler are used in the resin material: calcium carbonate at a particle distribution between 200 and 300 mesh, and ground recycled tire with a particle size distribution 20 mesh or smaller, preferably between 20 mesh and 200 mesh. The weight ratio between resin, hard filler (e.g., calcium carbonate) and elastic filler (e.g., recycled ground tire) can vary, for example, between 20% to 80%, 5% to 70% and 5% to 70%, respectively. In accordance with one embodiment, one of the components for producing the multi-component material can be about 50% resin, 25% calcium carbonate and 25% recycled ground tire, before the curing agent is added—though the exact proportions are not critical. A combination of the filler and resin (the combination referred to herein as a “base component”) can be mixed with a curing agent comprising an isocyanate and optionally a polymerization catalyst to cure the mixture. This mixture can be used to form an aerosol for spray application, for example, to form a coating on a substrate. When applied as described herein to a surface or substrate, this mixture produces a hard but flexible coating, typically between 0.5 mm and 10 mm in thickness, which has an outer surface with a higher coefficient of friction than an unfilled material made with the same polymeric matrix, partly due to surface irregularities. This filled multi-component material can provide improved friction and a surface with slight ‘give’, which can help control how easily items slide on or over the surface, and the cost of producing the filled material can be significantly lower than an unfilled multi-component material or even multi-component materials using different types of filler, by converting a waste product (old tires) into a new and useful durable product.

### System

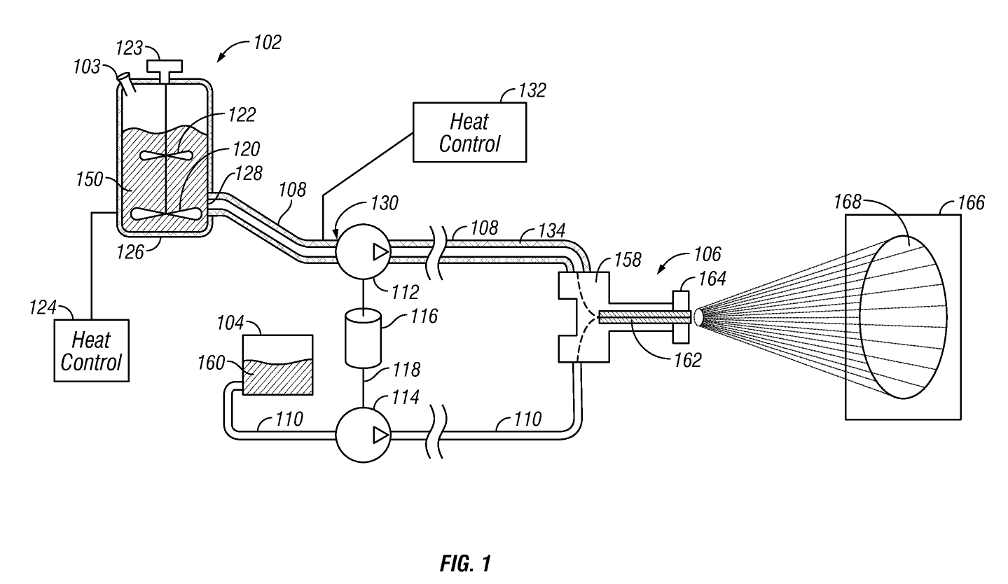

FIG. 1 illustrates an exemplary system 100 for mixing and dispensing highly filled multi-component material, including multi-component material comprising filler using recycled tire as discussed above. As shown in FIG. 1, the system 100 comprises a plurality (here two) of liquid component reservoirs 102 and 104 for supplying base component 150 and curing agent component 160, respectively, to a dispensing apparatus 106 via supply lines 108 and 110. Pumping mechanisms 112 and 114 are positioned along supply lines 108 and 110 for pumping component material to the dispensing apparatus 106. Pumping mechanisms 112 and 114 can be separate pumps, or they can be two pump heads driven by motor 116 via a common drive shaft, belt or chain 118.

Further to FIG. 1, the reservoir 102 can store, heat, and mix base component 150. The reservoir 102 can be in the form of a storage tank and can include an inlet 103 for receiving base component 150 and an outlet 128. The reservoir 102 also includes a apparatus for mixing the materials it holds, which can be a paddle-type stirrer, a spiral mixer, a jet mixer, a rotor/stator device, or other suitable mixing device. Preferably, the apparatus for mixing is an apparatus or combination that can create a stable flow to maintain sufficient homogeneity of the base component (as the base component can include filler or other materials that may settle if not mixed), provide a good heat transfer coefficient, and reduce or avoid introducing air into the base component stored in the reservoir 102. In some embodiments, the mixing apparatus uses one or more impellers driven by a motor. Suitable impellers include helical ribbon impellers, anchor impellers, screw impellers, flat blade turbine impellers, disc-style impellers, as well as axial-flow or pitched-blade turbine, propeller, and hydrofoil impellers. An external motor 123 can be used to power and control the speed of the impellers. FIG. 1 depicts a stirring device having two impellers, e.g., a combination of laminar flow impeller 120 positioned close to the bottom of the reservoir and radial impeller 122 positioned near the center of the reservoir. Mechanisms with more or fewer impellers can also be used, as can combinations of different types of mixing apparatus.

Reservoir 102 also includes heat control 124 and heating element 126 configured to heat the base component 150 to a predetermined temperature or temperature range and maintain the temperature of the base component within a predetermined temperature range. In accordance with one embodiment, a predetermined temperature range can be between 85 to 95 degrees Fahrenheit (29.4 to 35 Celsius). The heating element 124 can also comprise thermal insulation surrounding the reservoir to facilitate heating and maintaining the temperature of the base component 150 within a predetermined range.

Heating the base component can reduce clogging and accumulation of the reactive components as they pass through the system 100. The reactive material passing through system 100 can begin reacting with the other reactive component (e.g., when combined in dispensing apparatus 106 discussed in more detail below), which can cause some of the mixture to set in the system. Over time, a cumulative effect of the material setting in the system 100 can restrict passage through the system to a point of clogging. To reduce setting, system 100 includes controls to maintain the temperature of the material within a predetermined range. Thus, heat control can facilitate good mixing and avoidance of premature setting and maintain a desired consistency to ensure consistent delivery.

As illustrated in the embodiment of FIG. 1, system 100 can gravity feed the base component 150 from the reservoir 102 to pump 112. This can be done by positioning outlet port 128 of the reservoir 102 vertically higher than the inlet 130 of the pump 112. It is understood that additional or alternative forces, apart from just gravity, may also be exerted to feed pump 112 with base material from reservoir 102. For example, it is noted that base material 150 can also be drawn out of the reservoir 102 due to a vacuum/lower pressure (here, “vacuum” being used to refer to any pressure below prevailing atmospheric pressure) created at the pump inlet 130 during operation of pump 112.

Supply line 108 can be configured as described above to promote smooth flow of base material from the reservoir 126 to pump inlet 130, and to account for both static and dynamic effects on the heterogeneous filled mixture. In one embodiment, the line 108 can also be insulated and heated. A heating element and insulation 134—similar to heating element and insulation 126 used to heat the reservoir 102—can be used to heat a portion or all of the line 108, and can be controlled by heat controller 132. Heating the line 108 can maintain the temperature of the base material 150 as it moves through system 100. doing so can promote homogeneity of the base material flowing through the system 100, including through supply line 108, and reduce the likelihood that the pump 112 and/or dispensing apparatus 106 will jam due to agglomeration of the filler, particularly if the filler comprises large-sized rubber or plastic particles.

Referring back to FIG. 1, each of the pumping mechanisms 112 and 114 can be a gear pump head, and the two pump heads can be driven by a single motive force such as a motor linked to each pump head. Not only can gear pumping mechanisms provide reliable metering of the components making up the multi-component material, but gear pump mechanisms can also provide a substantially uniform flow when pumping, for example, the reactive components for a polyurethane-based materials.

The pumping mechanisms 112 and 114 can be coupled to one another (and/or motor 116) so that they are commonly driven (i.e. driven by a common motive force). For example, the pumping mechanisms 112 and 114 can be gear pump heads and can be rigidly connected along a single drive shaft 118. By doing so, there is no need for controllers and flow sensors to maintain the right mix ratio. Instead, the use of a common motive force by each of the pump mechanisms 112, 114 allows for a “ratio-metric” arrangement wherein, for example, each pump head rotor rotates at the same speed as the other pump head rotor (or at a constant relative speed as the other pump head), and when coupled with their output, can provide a precise matching of the outputs of the pumping mechanisms. Thus, such a pumping arrangement can be more reliable in terms of variations in metering and mix ratio (more precision) as well as equipment failure. Also, by driving the pumping heads 112 and 114 using a common shaft, the system 100 can be less costly to make, use and maintain.

In a variation, gearing (not shown) coupled to the drive shaft 118 can be used to establish ratios between the pump mechanisms so that the reactive components are metered in the precise mixing ratio desired, and so the ratio can be adjusted by adjusting the relative pumping rates.

Further to FIG. 1, the illustrated system 100 further comprises a dispensing apparatus 106, here comprising a manifold 158 adapted to receive the two components from respective one of the pump mechanisms 112 and 114. The manifold 158 can receive the components (base component 150 and curing agent 160) via separate lines 108 and 110. The two components are then introduced into mixing element 162, wherein the two components are mixed before dispensing. In the illustrated embodiment, a disposable static mixing element 162 using a touch-free atomizer device can be used. While a static mixer can be used, an active mixing device can be used if desired. A mixing element and atomizer that can be used in system 100 are described in U.S. Pat. No. 6,409,098 to Lewis et al., which is incorporated herein by reference in its entirety. The atomizer disperses the liquid mixture containing filler into an aerosol and directs the aerosolized material toward a surface to be coated with the multi-component material.

It is understood, too, that other delivery or application methods can be used to apply the mixed material, in conjunction with the above system for transferring and mixing the two components, and the invention is not limited to systems or methods that require aerosol delivery.

It is appreciated that the system 100 (including the dispensing apparatus 106) can be operated in an air-drive or airless configuration. In the exemplary embodiment, dispensing apparatus 106 can also comprises a pressurized air source (not shown) which is fed into the dispenser tip cap 164 as described in detail in the aforementioned incorporated U.S. Pat. No. 6,409,098. This approach can provide minimal or no appreciable physical contact between the mixed material and the internal passageways of the dispenser apparatus. Specifically, a disposable mixing element 162 and end cap 164 can be positioned so that a distal end or tip of the disposable mixing element projects a predetermined distance from the end of the cap 164, the latter being peripheral to the former. A plurality of atomizer holes (not shown) formed in the distal end of the cap 164 in a substantially symmetrical manner dispense pressurized air or other motive gas at a high velocity, thereby acting as an eductor/atomizer for the resin/filler/curing agent mixture combined within the mixing element 162. Thus, the cap 164 does not come into contact with any of the mixed material. If the sprayed material sets, which can occur because the mixed material tends to polymerize fairly quickly, the mixing element and/or atomizer can be replaced, or a disposable mixing element and/or atomizercan be used so that these can be discarded and new ones inserted for another spraying operation, such as when moving between two parts or areas to be treated. Due to the elimination of the necessity to clean the spray nozzle after each material application, the need for cleaning solvents is further eliminated by use of replaceable or disposable spray nozzle components. This makes the subject atomizer spray apparatus, along with the other aspects of the present embodiment previously described (e.g., using recycled tire as filler), “environmentally friendly”.

In an air-less embodiment of the above system, no air source is provided. Rather, the mixed material is forced out the tip of the mixing element 162 (or comparable structure) and poured or, expelled under pressure sufficient to “spray” the material in a desired pattern and density. The tip of the mixing element 164, for example, may be equipped with a diffuser (not shown) of the type well known in the art, whereby the velocity of the mixture molecules and the diffuser cooperate to deflect the trajectory of the molecules in various directions and to disperse the mixture into an aerosol or a stream. Other approaches may be used with equal success, e.g., the pressurized mixture stream may simply be dispensed as a stream without further shaping, or dispensed onto a surface and spread by a roller or brush.

Regardless of whether system 100 is an air-drive or airless configuration, system 100 can have a large diameter static mixing element to reduce the likelihood of the system clogging, in accordance with one embodiment. As explained earlier, system 100 can meter and dispense the rubber and plastic material filler having large and/or irregular geometric particle sizes. These particles can also have very high friction coefficients. These two characteristics, combined with pressure pushing a slurry solutions containing plastic, or rubber particles, through a restrictive area, like a small orifice of the dispensing apparatus, can create a an “agglomeration” effect that can clog the small orifice. This presents a potential risk that the material will clog the static mixers. To reduce the likelihood of the orifice clogging, a relatively large diameter static mixer can used in system 100, such as a static mixer having a ½ inch (1.27 cm) diameter.

### Method of Application

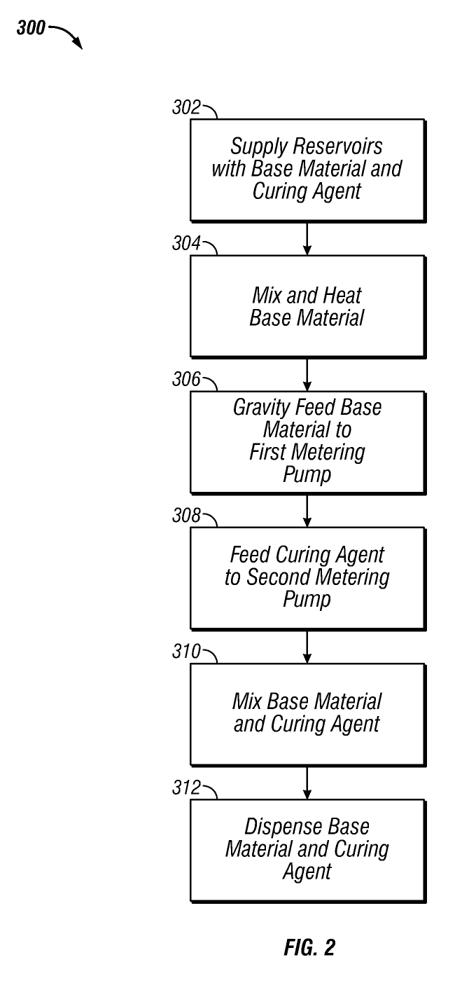

FIG. 2 is a flow diagram illustrating an exemplary process 300 of mixing, metering and dispensing filled multi-component material, in accordance with one embodiment. It should be appreciated that process 300 may include any number of additional or alternative tasks. The tasks shown in FIG. 2 need not be performed in the illustrated order and process 300 may be incorporated into a more comprehensive procedure or process having additional functionality not described in detail herein. For illustrative purposes, the following description of processes may refer to elements mentioned above in connection with FIG. 1.

In step 302, reservoirs 102 and 104 are filled or supplied with the respective reactive components (resin/filler and curing agent). Each reservoir 102 and 104 can be filled by pouring the component (or materials making up each component) into its respective reservoir through an opening, such as inlet 103 of the base material reservoir 102. In a variation, a reservoir, such as the curing agent reservoir 104, can comprise a bag containing the reactive component, wherein the bag includes a port connectable to the reactive component supply line. Such an arrangement is described in more detail in U.S. Patent Application Publication No. 2007/00000947 to Lewis et al., titled “Apparatus and Methods for Dispensing Fluidic or Viscous Materials,” and filed on Jul. 1, 2005, the entire content of which is incorporated herein by reference. Using such an arrangement, the bag containing the reactive material can be connected to a supply line in step 302.

In step 304, the base component in reservoir 102 can be mixed and heated. As described above, the reservoir 102 can include one or more impellors for maintaining sufficient homogeneity of the base component. In addition, the reservoir 102 includes a heating element 126 and heating control 124 to heat the base component in the reservoir 102 to a predetermined temperature and maintain the temperature within a predetermined temperature range. It is appreciated that the curing agent can be similarly heated and mixed, if doing so promotes better operation or formation of the multi-component material.

In step 306, the base component 150 and curing agent 160 are fed to respective pumping mechanisms 112 and 114. As discussed above, the base component 150 can be fed to pump/pump head 112 using gravity. Gravity can similarly be used to feed curing agent 160 to pump/pump head 114, or other forces can be used to feed curing agent in addition or instead of gravity, including, for example, vacuum pressure created by operation of the pumping mechanism 114, which can draw the curing agent from reservoir 104 to the pumping mechanism 114.

The base material and curing agent are metered by pump mechanisms 112 and 114, respectively, in step 308. Here, motor 116 is turned on (or engaged) to drive pump heads 112 and 114 via a common shaft (or chain or belt), 118. Pump mechanisms 112 and 114 hence meter a precise ratio of base component 150 and curing agent 160 and supply the metered base component 150 and curing agent 160 to the dispensing apparatus 116 via respective supply lines 110 and 108.

In step 310, the base component 150 and curing agent 160 can be mixed using static mixing element 162 in a chamber of dispensing apparatus 106. An exemplary process of mixing the reactive components (base material and curing agent) in a mixing chamber using a static mixing element (also referred to as a “static mixing tube”) is discussed in more detail in the aforementioned U.S. Pat. No. 6,409,098 to Lewis et al., incorporated herein by reference in its entirety.

At step 312, the mixed reactive components (base material 150 and curing agent 160) can be applied to surface 166. The curing agent 160 then cures the base material 150, causing the mixture to solidify into multi-component material 168 on surface 166.

In accordance with one embodiment, one or more of the steps of the process 300 can be implemented simultaneously. For example, in one variation, steps 304-312 are performed simultaneously.

It is appreciated that the present system is applicable to the dispensing of numerous different kinds of materials. Materials that can be sprayed in accordance with the principles of the present invention (with proper adaptation of the equipment) include, without limitation, paints, glues or adhesives, stucco, mastics, sealants, foams, undercoating, and other types of coatings, as well as other types of polymer based formulations that contain more than one component. It is especially useful for two-component materials that solidify after mixing of the two components and include particulate fillers, which are sprayed onto a surface in relatively thin layers.

Where a device or process is described herein as having a certain combination of features, it is understood that other features can be added too, as long as they do not interfere with the basic and novel features or operation of the device or process. Claims to a device or process described herein that use an open term such as ‘comprising’ or ‘including’ for a particular combination of features or steps, can alternatively “consist of” those features or steps, or “consist essentially of” those features or steps in accordance with the invention.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

We claim:

1. A substantially homogeneous mixture comprising:
(a) an elastic filler;
(b) at least one polyisocyanate monomer; and
(c) at least one polyalcohol monomer, or polyamine monomer, or mixture of a polyamine monomer and a polyalcohol monomer, which is capable of forming a polyurea, polyurethane or copolymer of polyurethane and polyurea by reacting with the polyisocyanate monomer.

2. The mixture of claim 1, wherein the elastic filler comprises 5-70% ground rubber tire filler having a particle size of about 20 mesh or smaller particle size.

3. The mixture of claim 1, which further comprises a catalyst to promote polymer forming reaction of the polyisocyanate monomer with the polyalcohol and/or polyamine monomer.

4. The mixture of claim 1, which is an aerosol.

5. The mixture of claim 1, further comprising a blowing agent or entrained air to promote formation of a foamed product.

6. A solid multi-component material comprising a polymeric matrix and elastic filler produced by polymerization of the mixture of claim 1, wherein the elastic filler comprises ground rubber tire.

7. The solid multi-component material of claim 6, wherein the polymeric matrix comprises polyurethane or polyurea.

8. A foamed multi-component material comprising a polymeric matrix and elastic filler produced by polymerization of the mixture of claim 1, wherein the elastic filler comprises ground rubber tire.

9. The solid multi-component material of claim 6, which is produced by spraying the mixture onto a surface under conditions where polymerization occurs.

10. The foamed multi-component material of claim 8, which is produced by spraying the mixture onto a surface under conditions where polymerization occurs.

11. A multi-component material comprising recycled ground rubber tire filler, which material is prepared by a process comprising the steps of:
(a) providing a first reactive component comprising a resin and recycled ground rubber tire filler;
(b) providing a second reactive component comprising a curing agent capable of curing the resin;
(c) mixing the first reactive component in a first reservoir to provide a substantially homogeneous mixture;
(d) metering the first reactive component and the second reactive component using respective first and second pumping mechanisms so a predetermined ratio of the first reactive component and the second reactive component are commingled, wherein the first and second pumps are optionally driven by a common motive force;
(e) mixing the first reactive component and the second reactive component to form a polymerization mixture; and
(f) dispensing the polymerization mixture onto a surface.

12. The multi-component material of claim 11, wherein the process of preparing the multi-component material further comprises gravity feeding the first reactive component to the first pumping mechanism through a supply line.

13. The multi-component material of claim 12, wherein at least a section of the supply line is heated.

14. The multi-component material of claim 11, wherein the first and second pumping mechanisms are gear pump heads driven by a common motive force.

15. The multi-component material of claim 14, wherein the common motive force is linked to the pumping mechanisms via a rigid mechanical connection.

16. The multi-component material of claim 11, wherein heating and mixing the first reactive component in a first reservoir results in the first reactive component being substantially homogeneous in the first reservoir.

17. The multi-component material of claim 11, wherein the process of preparing the multi-component material further comprises curing the mixed first and second reactive components.

18. The multi-component material of claim 11, wherein the step of dispensing comprises an application process selected from the group consisting of air spray, airless spray and extrusion.

19. The multi-component material of claim 8, wherein the first reactive component further comprises a resin and a hard filler, wherein the multi-component material is mixed at a predetermined mix ratio comprising between 20% to 80% resin by weight, between 5% to 70% hard filler by weight and between 5% to 70% recycled ground rubber tire filler by weight.

20. The multi-component material of claim 19, wherein the hard filler has a smaller particle size than the recycled ground rubber tire filler.

21. A multi-component material dispensing system configured to spray a multi-component material comprising a first reactive component and a second reactive component, the first reactive component comprising a resin and large particle filler with a particle size of about 20 mesh or smaller size, and the second reactive component comprising a curing agent, which system comprises:
(a) a dispensing apparatus comprising first and second inlet ports, an outlet port and a mixing chamber in fluid communication with each of the first and second inlet ports and the outlet port;
(b) a mixing element at least partially disposed in the mixing chamber configured to mix the first reactive component and the second reactive component;
(c) a first reservoir configured to store the first component, the first reservoir having a heating element configured to heat the first component to a predetermined temperature while the first component is stored in the reservoir and a mixer configured to mix the first component while the first component is stored in the reservoir;
(d) a second reservoir configured to store the second reactive component;
(e) a first pumping mechanism adapted to pump and meter the first reactive component from the first reservoir to the first port of the dispensing apparatus, wherein the first pumping mechanism and the first reservoir are physically connected by a heated transfer line; and
(f) a second pumping mechanism adapted to pump and meter the second reactive component from the second reservoir to the second port of the dispensing apparatus.

22. The multi-component material dispensing system of claim 21, wherein the first and second pumping mechanisms are both gear pump heads and are driven by a common motive force.

22. The multi-component material dispensing system of claim 21, wherein the mixing element is a disposable static mixer.

23. The multi-component material dispensing system of claim 21, wherein the mixing element has a proximal end and a distal end, the distal end extending partially out of the outlet port of the dispensing apparatus.

24. The multi-component material dispensing system of claim 21, wherein the mixing element has an outside diameter of about 0.5 inches (1.27 cm).

25. The multi-component material dispensing system of claim 21, wherein the spray system is capable of mixing a multi-component material at predetermined mix ratio.

26. The multi-component material dispensing system of claim 21, wherein the predetermined mix ratio comprises between 20% to 80% of a liquid resin material by weight, between 5% to 70% of a hard filler by weight and between 5% to 70% of an elastic filler by weight.

27. The multi-component material dispensing system of claim 26, wherein the elastic filler comprises recycled ground rubber tire.

28. The multi-component material dispensing system of claim 21, wherein one end of the transfer line coupled to an outlet of the first reservoir and the other end of the transfer line coupled to an inlet of the first pumping mechanism, wherein the outlet of the reservoir is positioned vertically higher than the inlet of the first pumping mechanism.

29. The multi-component material dispensing system of claim 21, wherein the first pumping mechanism and the second pumping mechanism are gear pump heads that are driven by a common motive force.

30. The multi-component material dispensing system of claim 21, wherein the first pumping mechanism and the second pumping mechanism are both gear pump heads and are driven by a motor via a common drive shaft.

31. The multi-component material dispensing system of claim 21, wherein the first pumping mechanism and the second pumping mechanism are both gear pump heads that are driven by a common rigid connection coupled to a motor.

32. The multi-component material dispensing system of claim 21, wherein the mixer of the first reservoir comprises at least one impellor positioned near the bottom of the reservoir.

33. A method of dispensing a multi-component material, comprising:
(a) mixing a first reactive component comprising between 20% to 80% resin by weight, 5% to 70% calcium carbonate by weight, and between 5% to 70% elastic filler by weight;
(b) maintaining the first reactive component within a predetermined temperature range;
(c) pumping the first reactive component to a first port of a dispensing apparatus using a first pumping mechanism;
(d) pumping a second reactive component to a second port of the a dispensing apparatus using a second pumping mechanism;
(e) mixing the first reactive component and the second reactive component in a mixing chamber of the dispensing apparatus, wherein the first reactive component and the second reactive component are mixed at a predefined mix ratio; and
(f) dispensing the mixed first and second reactive components onto a surface, wherein the mixed first and second reactive components form a substantially homogeneous mixture that solidifies.

34. The method of claim 33, wherein steps (a) and (b) are performed in a first reservoir, and the method further comprises gravity feeding the first reactive component from an outlet of the first reservoir to an inlet of the first pump via a heated transfer line.

35. A multi-component material produced by the steps of claim 33.

36. The multi-component material of claim 35, wherein steps (a)-(f) are performed simultaneously.

37. The multi-component material of claim 35, which is a substantially solid layer between about 0.5 mm and 10 mm in average thickness.

38. The multi-component material of claim 35, which is a foam.
